(19) United States
(12) Patent Application Publication
(10) Pub. No.: US 2003/0179381 A1
(43) Pub. Date: Sep. 25, 2003

(54) Sensor, color sensor and apparatus for inspection using the same

(75) Inventors: Takatoshi Kinoshita, Aichi (JP); Shintaro Washizu, Shizuoka (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/247,678

(22) Filed: Sep. 20, 2002

(30) Foreign Application Priority Data
Mar. 18, 2002 (JP) 2002-075235
Mar. 18, 2002 (JP) 2002-075238

(51) Int. Cl. G01B 9/02

(52) U.S. Cl. 356/450

(57) ABSTRACT

A sensor produced by aligning a capturing body including an amphiphilic rod-shaped body onto a substrate material in a film form or a sensor including an amphiphilic rod-shaped body and a capturing structure body being bonded to the rod-shaped body and specifically capturing a target substance, and a color sensor and apparatus for inspection using the sensors.

### BACKGROUND OF THE INVENTION

1. Field of the Invention

The present invention relates to a sensor, a color sensor capable of detecting a color (or a change in wavelength of an interference light) caused by a reflection of incident light as a colored interference light and an apparatus for inspection using the sensors.

2. Description of the Related Art

The vibration phenomenon in biological organisms is observed as pulse signals occurring in the reception and transmission of stimuli. The vibration phenomenon is one of important phenomena to maintain biological activities. Such vibration phenomenon is of interest as a diffusive structure formed at a non-equilibrium state far apart from equilibrium. For the purpose of elucidating the mechanism physico-chemically, the vibration phenomenon has been examined in various artificial membrane systems.

For membrane proteins of ionic channels and the like triggering pulse response, the structure and orientation of such proteins is thought to be significant for the expression of the functions.

Alternatively, biosensors using proteins have been investigated and developed in recent years, but not any of them is satisfactory in terms of sensitivity, operability and cost. Therefore, it has been desired to further modify and improve these biosensors.

### SUMMARY OF THE INVENTION

In such circumstances, it is an object of the present invention to overcome various problems of the related art and attain the following objects.

In other words, it is a first aspect of the present invention to provide a sensor capable of detecting a target substance at a high sensitivity and high reliability in a simple manner.

It is a second aspect of the present invention to provide a color sensor capable of detecting color from the reflection of incident light as a colored interference light, which can detect a great number of target substances efficiently at a high sensitivity.

It is a third aspect of the present invention to provide a highly potent apparatus for inspection using any one of the sensor and the luminescence sensor.

In the first aspect, the vibration or visco-elasticity sensor of the present invention is produced by aligning a capturing body including an amphiphilic rod-shaped body onto a substrate material, in a film form. The change of the mass or visco-elasticity due to the adsorption of a target substance on the film is detected in the form of frequency.

In the second aspect, further, the vibration or visco-elasticity sensor of the present invention is produced by aligning a capturing body including an amphiphilic rod-shaped body and a capturing structure body being bonded to the rod-shaped body and specifically capturing a target substance onto a substrate material, in a film form. The change of the mass or visco-elasticity due to the capture of the target substance with the capturing structure body is detected in the form of frequency at a high sensitivity.

In the first aspect, the color sensor of the present invention is produced by aligning a capturing body including an amphiphilic rod-shaped body onto a substrate material, in a film form. The reflection of incident light as a colored interference light based on the change of the refractive index or film thickness due to the adsorption of the target substance on the film can be detected as the change in the wavelength of the interference light or the change of the color tone by the color sensor.

In the second aspect, the color sensor of the present invention is produced by aligning a capturing body including an amphiphilic rod-shaped body and a capturing structure body being bonded to the rod-shaped body and specifically capturing a target substance onto a substrate material, in a film form. The reflection of incident light as a colored interference light based on the change of the refractive index or film thickness due to the capture of the target substance on the capturing structure body can be detected as the change in the wavelength of the interference light or the change of the color tone by the color sensor at a high sensitivity.

### BRIEF DESCRIPTION OF THE DRAWINGS

FIG. 1 is a schematic view depicting one example of the capturing body of the present invention.

FIG. 2 is a schematic view depicting one example of the other capturing body of the present invention.

FIG. 3 is an explanatory view depicting an example of the principle of the light reflection of an incident light as a colored interference light.

FIG. 4 is a schematic view depicting an example of the principle of the light reflection of an incident light as a colored interference light.

FIG. 5 is a schematic explanatory view depicting an example of the formation of a monolayer film with the capturing body of the present invention.

FIG. 6 is a schematic explanatory view depicting one example of the state of the amphiphilic capturing body aligned on water (aqueous phase).

FIG. 7 is a schematic explanatory view depicting one example of the method for arranging the amphiphilic capturing body to stand on water (aqueous phase).

FIG. 8A and FIG. 8B show an example of quartz oscillator; FIG. 8A is a plain view and FIG. 8B is a front view.

FIG. 9 is a schematic view depicting one example of the apparatus for inspection using the sensor.

FIG. 10 is a schematic plain view depicting an example of the surface acoustic wave (SAW) element.

FIG. 11 is a schematic view depicting one example of the apparatus for inspection using the luminescence sensor.

### DESCRIPTION OF THE PREFERRED EMBODIMENTS

The invention will now be described in more detail below.

### Sensor

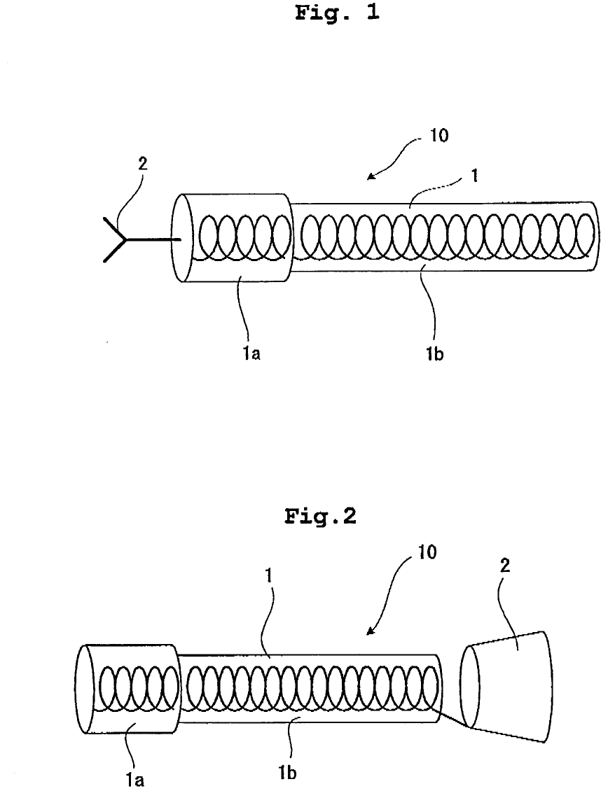

The capturing body 10 comprising the sensor in the first aspect of the present invention includes amphiphilic rod-shaped body 1 as shown in FIG. 1.

The capturing body 10 comprising the sensor in the second aspect of the present invention includes amphiphilic rod-shaped body 1 and capturing structure body 2 being aligned and bonded to the rod-shaped body 1 and specifically capturing a capturing subject 2, as shown in FIG. 2.

### Color Sensor

The capturing body 10 comprising the color sensor in the first aspect of the present invention includes amphiphilic rod-shaped body 1 as shown in FIG. 1.

The capturing body 10 comprising the color sensor in the second aspect of the present invention includes amphiphilic rod-shaped body 1 and capturing structure body 2 being bonded to the rod-shaped body 1 and specifically capturing a capturing subject 2, as shown in FIG. 2.

The sensor and the color sensor, both including the rod-shaped body and the capturing structure body in common, are now described below.

<Rod-Shaped Body>

The rod-shaped body is not particularly limited provided that it is rod-shaped, and may be appropriately selected in accordance with the object. The rod-shaped body may be either a rod-shaped inorganic substance or rod-shaped organic substance, but a rod-shaped organic substance is preferable.

Examples of rod-shaped organic substances are biopolymers, polysaccharides, and the like.

Suitable examples of biopolymers are fibrous proteins, α-helix polypeptides, nucleic acids (DNA, RNA), and the like. Examples of fibrous proteins are fibrous proteins having α-helix structures such as α-keratin, myosin, epidermin, fibrinogen, tropomyosin, silk fibroin, and the like. Suitable examples of polysaccharides are amylose and the like.

Among rod-shaped organic substances, spiral organic molecules whose molecules have a spiral structure are preferable from the standpoints of stable maintenance of the rod shape and internal intercalatability of other substances in accordance with an object. Among the aforementioned substances, those with spiral organic molecules include α-helix polypeptides, DNA, amylose, and the like.

{α-helix Polypeptides}

α-helix polypeptides are referred to as one of the secondary structures of polypeptides. The polypeptide rotates one time (forms one spiral) for each amino acid 3.6 residue, and a hydrogen bond, which is substantially parallel to the axis of the helix, is formed between a carbonyl group (—CO—) and an imides group (—NH—) of each fourth amino acid, and this structure is repeated in units of seven amino acids. In this way, the α-helix polypeptide has a structure which is stable energy-wise.

The direction of the spiral of the α-helix polypeptide is not particularly limited, and may be either wound right or wound left. Note that, in nature, only structures whose direction of spiral is wound right exist from the standpoint of stability.

The amino acids which form the α-helix polypeptide are not particularly limited provided that an α-helix structure can be formed, and can be appropriately selected in accordance with the object. However, amino acids which facilitate formation of the α-helix structure are preferable. Suitable examples of such amino acids are aspartic acid (Asp), glutamic acid (Glu), arginine (Arg), lysine (Lys), histidine (His), asparagine (Asn), glutamine (Gln), serine (Ser), threonine (Thr), alanine (Ala), valine (Val), leucine (Leu), isoleucine (Ile), cysteine (Cys), methionine (Met), tyrosine (Tyr), phenylalanine (Phe), tryptophan (Trp), and the like. A single one of these amino acids may be used alone, or two or more may be used in combination.

By appropriately selecting the amino acid, the property of the α-helix polypeptide can be changed to any of hydrophilic, hydrophobic, and amphiphilic. In the case in which the α-helix polypeptide is to be made to be hydrophilic, suitable examples of the amino acid are serine (Ser), threonine (Thr), aspartic acid (Asp), glutamic acid (Glu), arginine (Arg), lysine (Lys), asparagine (Asn), glutamine (Gln), and the like. In the case in which the α-helix polypeptide is to be made to be hydrophobic, suitable examples of the amino acid are phenylalanine (Phe), tryptophan (Trp), isoleucine (Ile), tyrosine (Tyr), methionine (Met), leucine (Leu), valine (Val), and the like.

In the α-helix polypeptide, the carboxyl group, which does not form a peptide bond and which is in the amino acid which forms the α-helix, can be made to be hydrophobic by esterification. On the other hand, an esterified carboxyl group can be made to be hydrophilic by hydrolysis.

The amino acid may be any of a L-amino acid, a D-amino acid, a derivative in which the side chain portion of a L-amino acid or a D-amino acid is modified, and the like.

The number of bonds (the degree of polymerization) of the amino acid in the α-helix polypeptide is not particularly limited and may be appropriately selected in accordance with the object. However, 10 to 5000 is preferable.

If the number of bonds (the degree of polymerization) is less than 10, it may not be possible for the polyamino acid to form a stable α-helix. If the number of bonds (the degree of polymerization) exceeds 5000, vertical orientation may be difficult to achieve.

Suitable specific examples of the α-helix polypeptide are polyglutamic acid derivatives such as poly(γ-methyl L-glutamate), poly(γ-ethyl L-glutamate), poly(γ-benzyl L-glutamate), poly(n-hexyl L-glutamate), and the like; polyaspartic acid derivatives such as poly(γ-benzyl L-aspartate) and the like; polyptides such as poly(leucine), poly(L-alamine), poly(L-methionine), poly(L-phenylalanime), poly(Lysine)-poly(γ-methyl L-glutamate), and the like.

The α-helix polypeptide may be a commercially available α-helix polypeptide, or may be appropriately synthesized or prepared in accordance with methods disclosed in known publications and the like.

As one example of synthesizing the α-helix polypeptide, the synthesis of block copolypeptide [poly(L-lysine)₂₅-poly(γ-methyl L-glutamate)₆₀]PLLZ₂₅-PMLG₆₀ is as follows. As is shown by the following formula, block copolypeptide [poly(L-lysine)₂₅-poly(γ-methyl L-glutamate)₆₀]PLLZ₂₅-PMLG₆₀ can be synthesized by polymerizing N^{ε}-carbobenzoxy L-lysine N^{α}-carboxy acid anhydride (LLZ-NCA) by using n-hexylamine as an initiator, and then polymerizing γ-methyl L-glutamate N-carboxy acid anhydride (MLG-NCA).

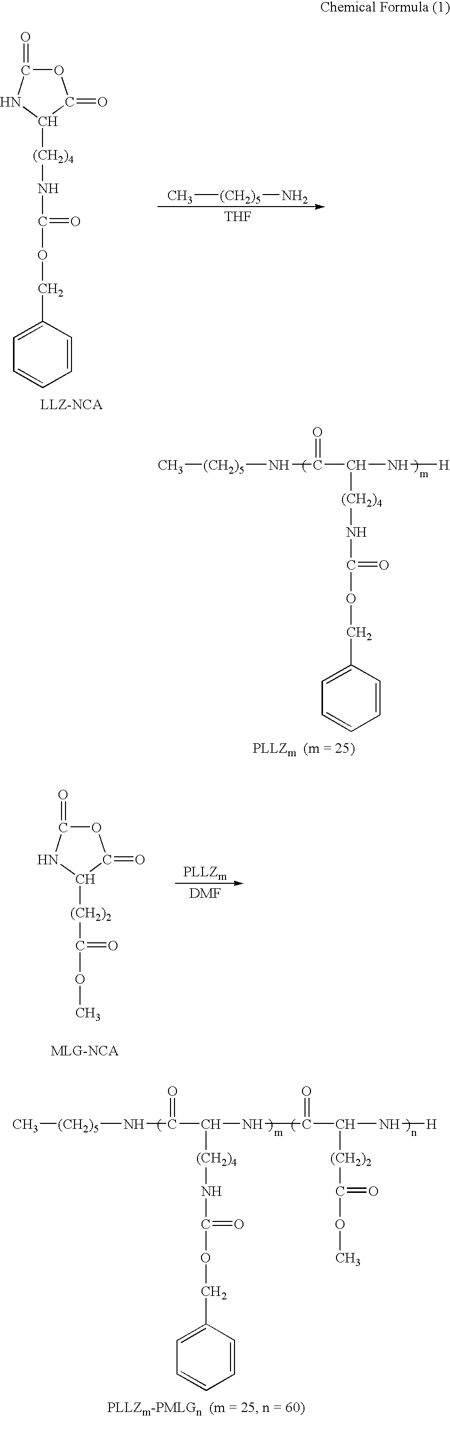

Synthesis of the α-helix polypeptide is not limited to the above-described method, and the α-helix polypeptide can be synthesized by a genetic engineering method. Specifically, the α-helix polypeptide can be manufactured by transforming a host cell by a expression vector in which is integrated a DNA which encodes the target polypeptide, and culturing the transformant, and the like.

Examples of the expression vector include a plasmid vector, a phage vector, a plasmid and phage chimeric vector, and the like.

Examples of the host cell include prokaryotic microorganisms such as E. coli, Bacillus subtilis, and the like; eukaryotic microorganisms such as yeast and the like; zooblasts, and the like.

The α-helix polypeptide may be prepared by removing the α-helix structural portion from a natural fibrous protein such as α-keratin, myosin, epidermin, fibrinogen, tropomyosin, silk fibroin, and the like.

{DNA}

The DNA may be a single-stranded DNA. However, the DNA is preferably a double-stranded DNA from the standpoints that the rod-shape can be stably maintained, other substances can be intercalated into the interior, and the like.

A double-stranded DNA has a double helix structure in which two polynucleotide chains, which are in the form of right-wound spirals, are formed so as to be positioned around a single central axis in a state in which they extend in respectively opposite directions.

The polynucleotide chains are formed by four types of nucleic acid bases which are adenine (A), thiamine (T), guanine (G), and cytosine (C). The nucleic acid bases in the polynucleotide chain exist in the form of projecting inwardly within a plane which is orthogonal to the central axis, and form so-called Watson-Crick base pairs. Thiamine specifically hydrogen bonds with adenine, and cytosine specifically hydrogen bonds with guanine. As a result, in a double-stranded DNA, the two polypeptide chains are bonded complementarily.

The DNA can be prepared by known method such as PCR (Polymerase Chain Reaction), LCR (Ligase Chain Reaction), 3SR (Self-Sustained Sequence Replication), SDA (Strand Displacement Amplification), and the like. Among these, the PCR method is preferable.

Further, the DNA can be prepared by being directly removed enzymatically from a natural gene by a restriction enzyme. Or, the DNA can be prepared by a genetic cloning method, or by a chemical synthesis method.

In the case of a genetic cloning method, a large amount of the DNA can be prepared by, for example, integrating a structure, in which a normal nucleic acid has been amplified, into a vector which is selected from plasmid vectors, phage vectors, plasmid and phage chimeric vectors, and the like, and then introducing the vector into an arbitrary host in which propagation is possible and which is selected from prokaryotic microorganisms such as E. coli, Bacillus subtilis, and the like; eukaryotic microorganisms such as yeast and the like; zooblasts, and the like.

Examples of chemical synthesis methods include liquid phase methods or solid phase synthesis methods using an insoluble carrier, such as a tolyester method, a phosphorous acid method, and the like. In the case of a chemical synthesis method, the double-stranded DNA can be prepared by using a known automatic synthesizing device and the like to prepare a large amount of single-stranded DNA, and thereafter, carrying out annealing.

{Amylose}

Amylose is a polysaccharide having a spiral structure in which D-glucose, which forms starch which is a homopolysaccharide of higher plants for storage, is joined in a straight chain by α-1,4 bonds.

The molecular weight of the amylose is preferably around several thousand to 150,000 in number average molecular weight.

The amylose may be a commercially available amylose, or may be appropriately prepared in accordance with known methods.

Amylopectin may be contained in a portion of the amylose.

The length of the rod-shaped body is not particularly limited, and may be appropriately selected in accordance with the object. However, from the standpoint of causing reflection of the incident light as colored interference light which will be described later, a length of 810 nm or less is preferable, and 10 nm to 810 nm is more preferable.

The diameter of the rod-shaped body is not particularly limited, and is about 0.8 to 2.0 nm in the case of the α-helix polypeptide.

The entire rod-shaped body may be hydrophobic or hydrophilic. Or, the rod-shaped body may be amphiphilic such that a portion thereof is hydrophobic or hydrophilic, and the other portion thereof exhibits the opposite property of the one portion.

In the case of an amphiphilic rod-shaped body, the numbers of the lipophilic (hydrophobic) portions and hydrophilic portions are not particularly limited, and may be appropriately selected in accordance with the object. Further, in this case, the portions which are lipophilic (hydrophobic) and the portions which are hydrophilic may be positioned alternately, or either type of portion may be positioned only at one end portion of the rod-shaped body.

Here, one example of the amphiphilic rod-shaped body is shown in FIG. 1. As shown in the figure, the rod-shaped body 1 has a lipophilic (hydrophobic) portion la on one end while having amphiphilic portion on the other end thereof.

The rod-shaped body preferably exhibits a property to reflect an incident light as a colored interference light from the standpoint of good visibility and identification.

The reflection of the incident light as colored interference light is a color formation on the basis of a multi-layer thin film interference theory which is a basic principle for color formation of the scaly powder of the wings of a Morpho butterfly and is a color formation on the film as a result of reflection of light of specific wavelength corresponding to the thickness of the film and the refractivity thereof when stimulation from outside such as electric field, magnetic field, heat, light (for example, natural light, infrared light and ultraviolet light), and the like is applied to the film. The color tone may be freely controlled like the surface skin of a chameleon by the stimulation from outside.

Principle of light reflection of an incident light as colored interference light will be described hereinafter.

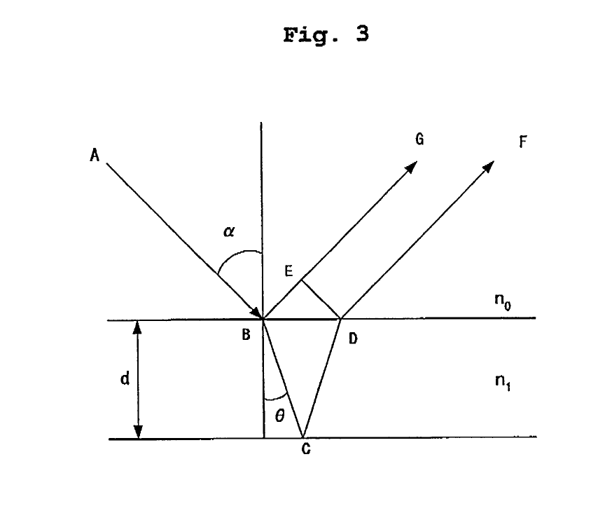

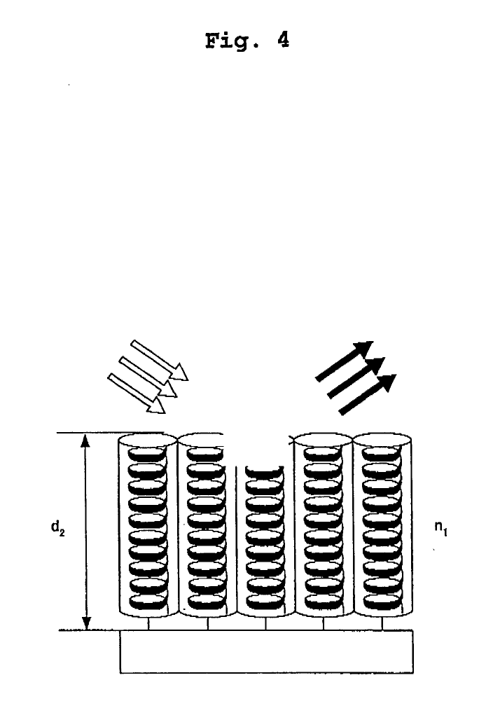

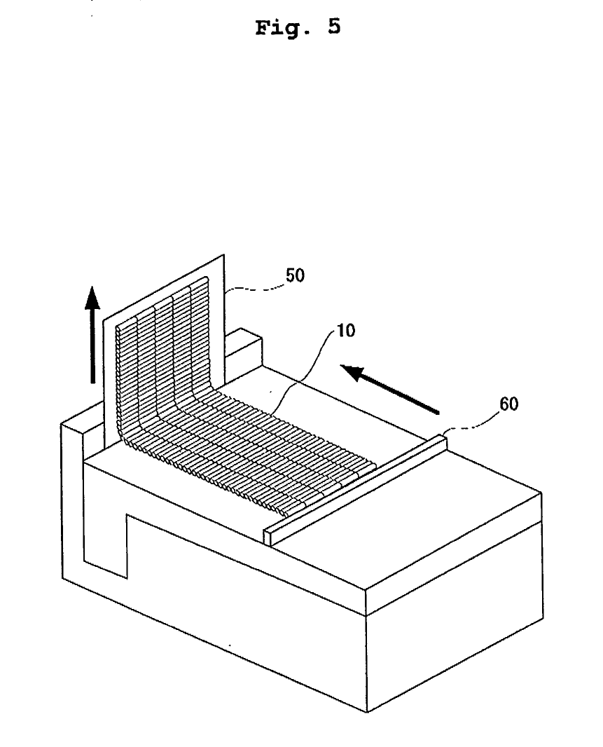

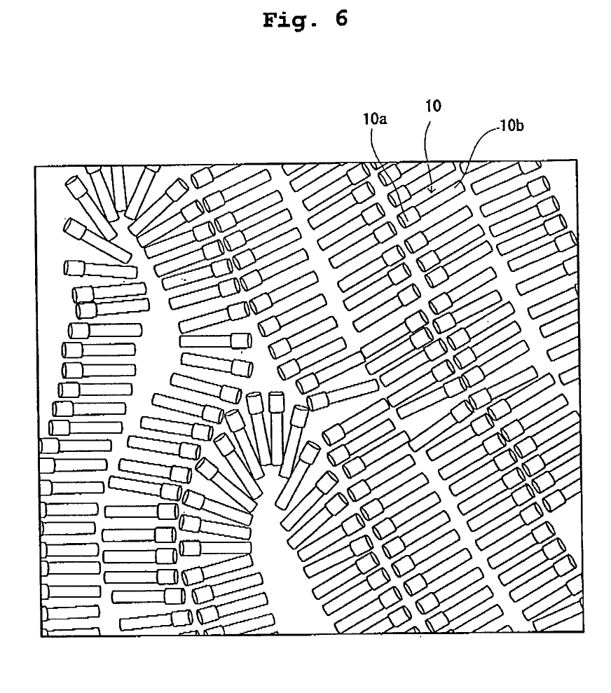

As shown in FIG. 3 and FIG. 4, when light is irradiated on the film of the rod-shaped body, wavelength (λ) of the interference light by the film is emphasized under the condition as shown in the following (1) and enfeebled under the condition as shown in the following (2).

$$\begin{matrix}λ = \frac{2 t1}{m} \sqrt{{n}^{2} - {sin}^{2} α} & ( 1 ) \\ λ = \frac{4 t1}{2 m - 1} \sqrt{{n}^{2} - {sin}^{2} α} & ( 2 )\end{matrix}$$

In the formulae (1) and (2), λ means wavelength (nm) of the interference light, a means angle of incidence (degree) of the light to the film, t means thickness (nm) of a single film, 1 means number of layers of the film, n means a refractive index of the film and m means an integer of 1 or more.

The light reflection of the incident light as colored interference light may be obtained by aligning the sensor into a film-like shape.

Thickness of the single film is preferably 810 nm or less and, more preferably, it is from 10 nm to 810 nm.

When the thickness is appropriately changed, color (wavelength) of the interference light may be changed.

The film may either be a monomolecular film or a multiple layered monomolecular films.

The monomolecular film or the layered films comprising the same may be formed by, for example, a Langmuir-Brodgett method (LB method) and, in that case, a known LB film forming apparatus (such as NL-LB 400 NK-MWC manufactured by Nippon Laser & Electronics Laboratories) may be used.

Formation of the monomolecular film may be carried out, for example, in such a state that the rod-shaped body which is lipophilic hydrophobic) or amphiphilic is floated on water surface (on an aqueous phase) or in such a state that the rod-shaped body which is lipophilic (hydrophobic) or amphiphilic is floated on oil surface (on an oil phase) or, in other words, the rod-shaped body 1 is aligned as shown in FIG. 4 so as to form on a substrate 50 using an pushing material 60. When such an operation is repeatedly carried out, the layered films where the monomolecular films are layered in any number may be formed on the substrate 50. Incidentally, it is preferred that the monomolecular film or the layered film is fixed on the substrate 50 since the reflection of the incident light as colored interference light by the monomolecular film or layered films is expressed in a stable manner.

In that case, there is no particular limitation for the substrate 50 and, according to the object, its material, shape, size, and the like may be appropriately selected although it is preferred that its surface is appropriately subjected to a surface treatment previously with an object that the rod-shaped body 1 is easily adhered or bonded thereto. When the rod-shaped body 1 (such as α-helix polypeptide) is hydrophilic for example, it is preferred that a surface treatment such as hydrophilizing treatment using octadecyl trimethylsiloxane and the like is previously carried out.

With regard to the state where the rod-shaped body is floated on an oil phase or an aqueous phase in the formation of the monomolecular film of the amphiphilic rod-shaped body, the lipophilic areas (hydrophobic areas) 1a of the rod-shaped body 1 are aligned in an adjacent state to each other on the aqueous phase or oil phase while the hydrophilic areas 1b are aligned in an adjacent state each other as shown in FIG. 6.

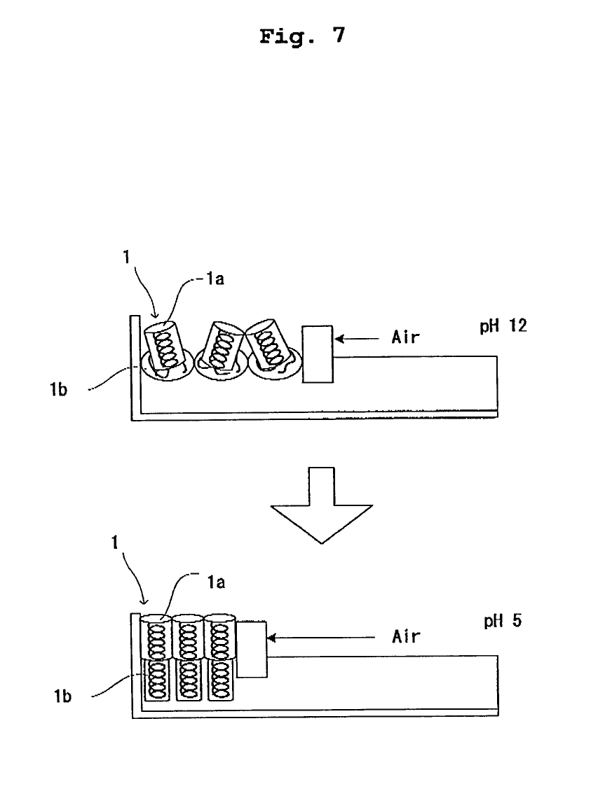

The above is an example of a layered membrane or a layered films comprising the same where the rod-shaped body is aligned in the plane direction of the monomolecular film (in a horizontal state) while a monomolecular film where the rod-shaped body is aligned in the thickness direction of the monomolecular film (in a vertical state) may be manufactured, for example, as follows. First, as shown in FIG. 7, water (aqueous phase) is made alkaline of around pH 12 under such a state that the amphiphilic rod-shaped body 1 (α-helix polypeptide) is floated on the water surface (aqueous phase) (i.e., in a horizontal state). As a result, in the hydrophilic area 1b in the rod-shaped body 1 (α-helix polypeptide), the α-helix structure thereof is disentangled to give a random structure. At that time, the lipophilic area (hydrophobic area) 1a of the rod-shaped body 1 (α-helix polypeptide) maintains its α-helix structure. Then, the pH of the water (aqueous phase) is made acidic to about 5 thereby the hydrophilic area 1b in the rod-shaped body 1 (α-helix polypeptide) forms an α-helix structure again. When the pushing material bonded to the rod-shaped body 1 (α-helix polypeptide) is pushed by the pressure of air from its side to the rod-shaped body 1 (α-helix polypeptide), the rod-shaped body 1 maintains vertical against water (aqueous phase) while its hydrophilic area 1b forms an α-helix structure in the direction substantially orthogonal to the water surface in the aqueous phase. When the aligned rod-shaped body 1 (α-helix polypeptide) is pushed out onto the substrate 50 using a pushing material 60 as mentioned above by referring to FIG. 4, it is possible to form a monomolecular film on the substrate 50. When such operation is repeatedly carried out, the layered films having prescribed number of monomolecular film may be formed on the substrate 50.

{Capturing Structured Element}

The capturing structured element is not particularly limited provided that it is able to capture the object to be captured and may be suitably selected according to an object.

Examples of capturing modes include, but are not limited to, physical adsorption, chemical adsorption, and the like. These modes allows formation of bonds by, for example, by hydrogen bonding, intermolecular forced (van der Waals force), coordinate bonding, ionic bonding, covalent bonding, and the like.

Particular examples of the capturing structured element preferably include, host components involved in clatharate compound (hereinafter, interchangeably referred to as “host”), antibody, nucleic acid, hormone receptor, lectin, and physiologically active agent receptor. Among all, nucleic acid is preferred in view of easy formation of any alignment and more preferably, single-stranded DNA or single-stranded RNA.

With regard to an object to be captured of such a capturing structured element, which may be a guest (component to be included) in the case of clatharate compound, an antigen in the case of antibody, a nucleic acid, a tubulin, a chitin and the like in the case of nucleic acid, a hormone in the case of hormone, sugar and the like in the case of lectin, and a physiologically active substance in the case of physiologically active agent receptor.

{Clatharate Compound}

The clatharate compound is not particularly limited provided that it posses molecular recognizing ability (host-guest binding ability) and may be appropriately selected according to an object. Preferable examples of such clatharate compound include the ones having tubular (one-dimensional) hollow, or layer-shaped (two-dimensional) hollow, or cage-shaped (three-dimensional) hollow, and the like.

Examples of the clatharate compound having the tubular (one-dimensional) hollow are, urea, thiourea, deoxycholic acid, dinitrodiphenyl, dioxytriphenylmethane, triphenylmethane, methylnaphthalene, spirochroman, PHTP (perhydrotriphenylene), cellulose, amylose, cyclodextrin (where the hollow is cage-shaped in a solution), phenylboric acid, and the like.

Examples of an object to be captured (the guest) by the urea, may be n-paraffin derivatives, and the like.

Examples of an object to be captured (the guest) by the thiourea, may be branched or cyclic hydrocarbons and the like.

Examples of an object to be captured (the guest) by the deoxycholic acid, may be paraffins, fatty acids, aromatic compounds, and the like

Examples of an object to be captured (the guest) by the dinitrodiphenyl, may be diphenyl derivatives, and the like.

Examples of an object to be captured (the guest) by the dioxytriphenylmethane, may be paraffins, n-alkenes, squalene, and the like.

Examples of an object to be captured (the guest) by the triphenylmethane, may be paraffins, and the like.

Examples of an object to be captured (the guest) by the methylnaphthalene, may be C₁₆ or less n-paraffins, branched paraffins, and the like.

Examples of an object to be captured (the guest) by the spirochroman, may be paraffins, and the like.

Examples of an object to be captured (the guest) by the PHTP (perhydrotriphenylene), may be chloroform, benzene, various high-molecular substances, and the like.

Examples of an object to be captured (the guest) by the cellulose, may be H₂O₂, paraffins, CCl₄, dyes, iodine, and the like.

Examples of an object to be captured (the guest) by the amylose, may be fatty acids, iodine, and the like.

The cyclodextrin is a cyclic dextrin which is formed by degradation of starch using amylase and three types are presently known. Namely, α-cyclodextrin, β-cyclodextrin and γ-cyclodextrin. In the present invention, the cyclodextrin includes cyclodextrin derivatives where a part of hydroxyl groups thereof are substituted with other functional group such as, for example, alkyl group, allyl group, alkoxy group, amide group, sulfonic acid group, and the like.

Examples of an object to be captured (the guest) by the cyclodextrin, may be phenyl derivatives such as thymol, eugenol, resorcinol, ethylene glycol monophenyl ether, 2-hydroxy-4-methoxybenzophenone, and the like, benzoic acid derivatives and esters thereof such as salicylic acid, methyl p-hydroxybenzoate, ethyl p-hydroxybenzoate, and the like, steroids such as cholesterol, and the like, vitamins such as ascorbic acid, retinol, tocopherol, and the like, hydrocarbons such as limonene, and the like, allyl isothiocyanate, sorbic acid, iodine molecule, Methyl Orange, Congo Red, potassium 2-p-toluidinylnaphthalene-6-sulfonate (TNS), and the like.

Examples of an object to be captured (the guest) by the phenylboric acid, may be glucose, and the like.

Examples of a layered (two-dimensional) clatharate compound, may be clay mineral, graphite, smectite, montmorillonite, zeolite, and the like.

Examples of an object to be captured (the guest) by the clay mineral, may be hydrophilic substances, polar compounds, and the like.

Examples of an object to be captured (the guest) by the graphite, may be O, HSO₄⁻, halogens, halides, alkaline metals, and the like.

Examples of an object to be captured (the guest) by the montmorillonite, may be brucine, codeine, o-phenylenediamine, benzidine, piperidine, adenine, guianine and liposide thereof, and the like.

Examples of an object to be captured (the guest) by the zeolite, may be H₂O, and the like.

With regard to the cage-shaped (three-dimensional) clatharate compound, examples include hydroquinone, gaseous hydrate, tri-o-thymotide, oxyflavan, dicyanoammine nickel, cryptand, calixarene, crown compound, and the like.

Examples of an object to be captured (the guest) by the hydroquinone, may be HCl, SO₂, acetylene, rare gas elements, and the like.

Examples of an object to be captured (the guest) by the gaseous hydrate, may be halogens, rare gas elements, lower hydrocarbons, and the like.

Examples of an object to be captured (the guest) by the tri-o-thymotide, may be cyclohexane, benzene, chloroform, and the like.

Examples of an object to be captured (the guest) by the oxyflavan, may be organic bases, and the like.

Examples of an object to be captured (the guest) by the dicyanoammine nickel, may be benzene, phenol, and the like.

Examples of an object to be captured (the guest) by the cryptand, may be NH₄⁺, various metal ions, and the like.

The calixarene is a cyclic oligomer where a phenol unit synthesized from phenol and formaldehyde under a suitable condition is bonded to a methylene unit and its 4- to 8-nuclear substances are known. Among them, examples of an object to be captured (the guest) by the p-tert-butylcarixarene (n=4) may include, chloroform, benzene, toluene, and the like, examples of an object to be captured (the guest) by the p-tert-butylcarixarene (n=5) may include, isopropyl alcohol, acetone, and the like, examples of an object to be captured (the guest) by the p-tert-butylcarixarene (n=6) may include, isopropyl alcohol, acetone, and the like, chloroform, methanol, and the like, and examples of an object to be captured (the guest) by the p-tert-butylcarixarene (n=7) may include, chloroform, and the like.

The crown compound includes a macro cyclic compound having not only a crown ether having oxygen as an electron-donating donor atom but also donor atom such as nitrogen, sulfur, and the like as an analog thereof as constituting elements for a ring structure, and also includes a multicyclic crown compound comprising two or more rings represented by cryptand for example, cyclohexyl-12-crown-4, dibenzo-14-crown-4, tert-butylbenzo-15-crown-5, dibenzo-18-crown-6, dicyclohexyl-18-crown-6, 18-crown-6, tribenzo-18-crown-6, tetrabenzo-24-crown-8, dibenzo-26-crown-6, and the like.

Examples of an object to be captured (the guest) by the crown compound, may be various metal ions such as alkaline metals (e.g., Li, Na and K) and alkaline earth metals (e.g., Mg and Ca), NH₄⁺, alkylammonium ion, guanidium ion, aromatic diazonium ion, and the like and the crown compound forms a complex therewith. Examples of an object to be captured (the guest) by the crown compound, may further include polar organic compounds having C—H (acetonitrile, malononitrile, adiponitrile, and the like), N—H (aniline, aminobenzoic acid, amide, sulfamide derivative, and the like) and O—H (phenol, acetic acid derivative, and the like), unit where acidity is relatively high and the crown compound forms a complex therewith.

The size (or the diameter) of the hollow of the clatharate compound is not particularly limited and may be suitably selected according to an object. However, from a standpoint of achieving stable molecular recognizing ability (host-guest binding ability), 0.1 nm to 2.0 nm in diameter is preferred.

A mixing rate (molar ratio) of the clatharate compound (host) to the guest cannot be determined at a fixed rate, and may differ according to the type of the clatharate compound and the type of the guest. However usually the rate (clatharate compound):(guest component) is from 1:0.1 to 1:10 and, preferably, from 1:0.3 to 1:3.

{Antibody}

The antibody is not particularly limited provided that it causes an antigen-antibody reaction specifically with the target antigen (object to be captured). As such, it may be either a polyclonal antibody or a monoclonal antibody and it also may be Fab′, Fab, F(ab′)₂, and the like of IgG, IgM, IgE and IgG.

There is no particular limitation for the target antigen but it may be appropriately selected depending on the object. Examples include plasma protein, tumor marker, apoprotein, virus, autoantibody, coagulation/fibrinolysis factor, hormone, blood drugs, HLA antigen, and the like.

{Protein Having Affinity to Heavy Metals}

The protein of a low molecular weight (about 6000-13,000) having a high affinity to many heavy metals, particularly to zinc, cadmium, copper, mercury, and the like, existing in liver, kidney and other tissues of animals and being also found in microbes recently. In addition, such a protein contains certain amount of cysteine, shows an amino acid distribution containing almost no aromatic residue and is an important substance having a detoxicating function for cadmium, mercury, and the like. in vivo and participating in storage of essential minor metal for living body such as zinc and copper and in distribution thereof in vivo as well.

{Object to be Captured}

The object to be captured is preferably at least one material selected from heavy metals, toxic organic compounds, agricultural chemicals, endocrine disruptors in the environment and genetic recombinant cells. It is not necessary that the object to be captured is not the final target substance for the detection but may be a substance which coexist with the final target substance for the detection.

For the above-mentioned heavy metals, examples such as alkyl mercury compound (R—Hg), mercury or its compound (Hg), cadmium or its compound (Cd), lead or its compound (Pb), hexavalent chromium (Cr⁶⁺), copper or its compound (Cu), zinc or its compound (Zn), cyan, hexavalent chromium, arsenic, selenium, manganese, nickel, iron, zinc, selenium, tin, and the like may be used.

For the toxic organic compounds, examples such as cyan compound, phenols, dichloromethane, ammonia, carbon tetrachloride, 1,2-dichloroethane, 1,1-ichloroethylene, cis-1,2-dicloroethylene, 1,1,1-tricloroethane, 1,1,2-tricloroethane, trichloroethylene, tetrachloroethylene, benzene, 1,3-dichlorobenzene, dioxin, PCB, DDT, DES, and the like may be used.

For the agricultural chemicals, there may be examples such as organ phosphorus, 1,3-dichloropropene, thiraum, simazine, thiobencarb, and the like may be used.

For the endocrine disruptors in the environment, examples include bisphenol A, nonylphenol, phthalates, organotin compounds, DDT, PCB, dioxins, and the like.

For the genetic recombinant cells, examples include corn, rice plant, tomato, and the like.

<Sensor and Apparatus for Inspection Using the Same>

The sensor of the present invention is produced by aligning the capturing body onto a quartz oscillator or a surface acoustic wave (SAW) element, in a film form.

The sensor in the first aspect of the present invention is produced by aligning the capturing body 10 including the amphiphilic rod-shaped body 1 shown in FIG. 1 onto a quartz oscillator or a surface acoustic wave (SAW) element, in a film form.

The sensor in the second aspect of the present invention is produced by aligning the capturing body 10 including the amphiphilic rod-shaped body 1 shown in FIG. 2 and the capturing structure body 2 being bonded to the rod-shaped body and specifically capturing a target substance onto a quartz oscillator or a surface acoustic wave (SAW) element, in a film form.

Further, the apparatus for inspection of the present invention includes the sensor, an oscillation circuit with an oscillation in the form of frequency concerning the change of the mass or visco-elasticity due to the attachment or capture of a target substance on the sensor, a frequency counter counting the frequency generated from the oscillation circuit.

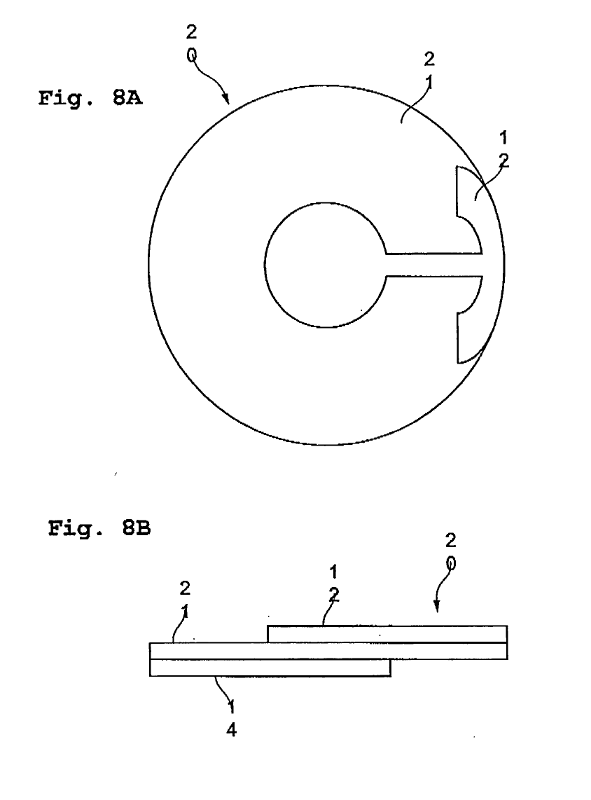

In the quartz oscillator, metal electrodes are vapor deposited on the surface and the back of a thin quartz plate. An example of the quartz oscillator 20 is shown in FIGS. 8A and 8B. FIG. 8A is a plane view while FIG. 8B is a front view. An electrode 12 is vapor deposited on the surface of the quartz plate 21 while another electrode 14 is vapor deposited on the back thereof. The electrodes extend to the left side from the electrodes 12, 14 and the left ends thereof are connected to clip-type lead wires (not shown) followed by connecting to an alternating current source (not shown). When alternating current is applied between the electrodes 12, 14, there is generated oscillation of a predetermined period in the quartz plate 21 due to a back piezoelectric effect.

On the surface of the quartz oscillator 20, there is adhered and bonded a sensor film (not shown). The capturing bonding material of this sensor film captures the object to be captured and mass of the surface of the quartz oscillator 20 changes corresponding to the mass of the captured object to be captured whereby the resonance frequency changes.

Here, between the changes in the resonance frequency and changes in the mass of the sensor film coated on the surface of the quartz oscillator 20 which oscillates in parallel to the plane vertical to the thickness direction, there is a relation as shown in the following formula (3) whereby changes in the mass may be detected from changes in the resonance frequency. For example, in the case of an oscillator of resonance frequency of 9 MHz (area: about 0.5 cm²), a reduction in frequency of 400 Hz is resulted by an increase in mass of 1 μg.

ΔF=−2.3×10⁶ (F²×ΔW/A) (3)

In the formula, F means resonance frequency (MHz) of the quartz oscillator, ΔF means changes (Hz) in the resonance frequency by changes in mass, ΔW means changes in mass (g) of the film and A means a surface area (cm²) of the film.

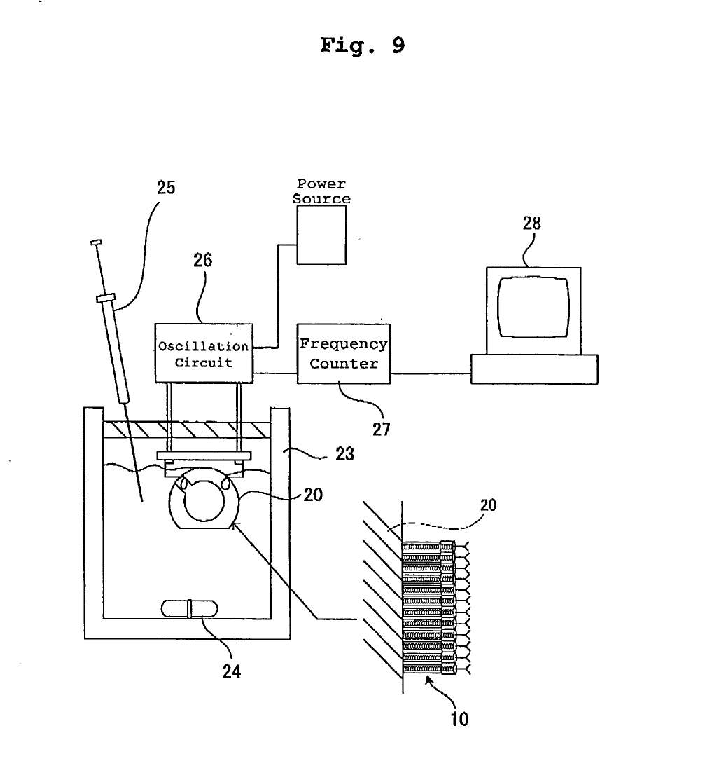

An example of the apparatus for inspection is shown in FIG. 9. The quartz oscillator 20 (sensor 10 is bonded on the surface in a film-like shape) is attached to an arm for attaching the quartz oscillator and dipped in a solution in a thermostat heat block 23. The thermostat heat block 23 is to keep the temperature of the solution constant. The solution is stirred by a stirrer 24. In a sample injection 25, a sample to be measured is injected into a solution. In the oscillation circuit 26, alternating current field is applied to the electrodes 12, 14 of the quartz oscillator 20 to oscillate the quartz oscillator 20. Oscillation frequency of the oscillation circuit 26 is counted by a counter 27, analyzed by a computer 28 and mass of the object to be captured in the sample is displayed.

The object to be captured is specifically captured as such by the capturing bonding material of the sensor in which mass of the sensor changes. The change in the mass is detected by the quartz oscillator and converted to frequency and, therefore, when the change in frequency is measured by the frequency counter, the presence or absence of the object to be captured may be specifically inspected.

When a calibration curve is previously prepared using an object to be captured of a known amount, the object to be captured concentration to be detected or quantified in the sample may be detected or quantified.

The surface acoustic wave (SAW) element is an element where a pair of comb-shaped electrodes is set on the surface of the solid and electric signal is converted to a surface acoustic wave (sonic wave transmitting the solid surface, ultrasonic wave), transmitted to the encountering electrode and outputted as electric signal again whereby signal of specific frequency corresponding to the stimulation may be taken out. Ferroelectric a substance such as lithium tantalite and lithium niobate, quartz, zinc oxide thin film, and the like are used as the material therefor.

The SAW is elastic wave which transmits along the surface of the medium and exponentially decreases in the inside area of the medium. In the SAW, the transmitted energy is concentrated on the surface of the medium whereby the changes in the medium surface may be sensitively detected and, as a result of the changes in the mass of the surface, the SAW transmitting velocity changes as same as in the case of quartz oscillator. Usually, SAW transmitting velocity is measured as the changes in oscillation frequency using an oscillation circuit. Changes in the oscillation frequency are given by the following formula.

Δf=(k₁+k₂)f²hp−k₂f²h[(4μ/Vᵣ²)(λ+μ/λ+2μ)]

In the formula, k₁ and k₂ mean constants, h means thickness of the fixed film, ρ means density of the film, λ and μ mean Lame constants of the film and Vᵣ means a SAW transmitting velocity.

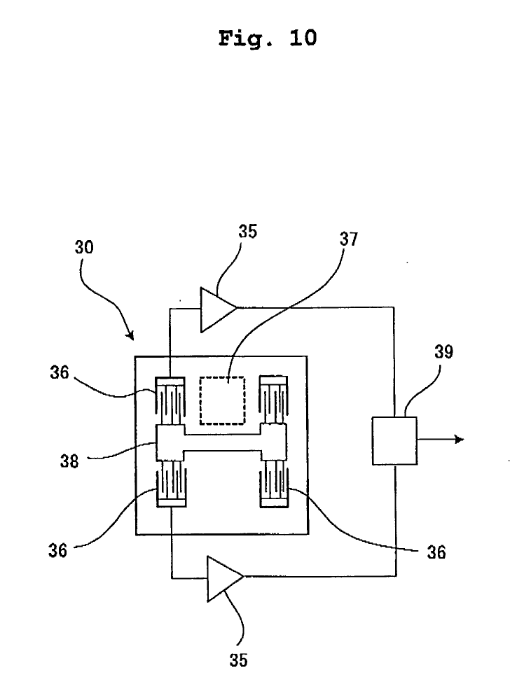

FIG. 10 is a schematic plane view which shows an example of constitution of main parts of a surface acoustic wave (SAW) element. In FIG. 10, in the SAW element sensor 30, there are formed gold electrode 38 and comb-shaped electrodes 36 at both ends thereof on the SAW element having a resonance frequency of 90 MHz made of an ST cut quartz and there is formed a film (not shown) comprising the sensor in the surface wave transmitting region 37 as shown by dotted lines. The sensor is connected to a frequency counter 39 from each comb-shaped electrode 36 via a high-frequency amplifier 35 whereby the mass of the object to be captured in the sample is displayed.

The object to be captured in the sample is specifically captured by the capturing bonding material of the sensor whereby mass or viscoelasticity of the sensor changes, the mass change or viscoelasticity change is detected by the surface acoustic wave (SAW) element and converted to frequency and, therefore, when this frequency change is measured by the frequency counter, it is now possible to specifically examine whether or not the object to be captured is present.

When a calibration curve is previously prepared using an object to be captured of a known amount, the object to be captured to be detected or quantified in the sample may be detected or quantified.

With regard to a method for a chemical bonding/fixing of the sensor on the electrodes of the quartz oscillator or the surface acoustic wave (SAW) element which constitutes the biosensor, there is no particular limitation and that may be appropriately selected according to the object. For example, that may be carried out by means of a chemical bond such as covalent bond.

With regard to the covalent bond method, there is no particular limitation but the same one which is used for bonding the capturing bonding material to the rod-shaped body in the sensor may be appropriately selected and used.

To be specific, there may be exemplified a method where a substance where thiol group is introduced into the end of the sensor is synthesized, the quartz oscillator or the surface acoustic wave (SAW) element is dipped in its solution and made to react therewith for a predetermined time and then the biosensor to which the sensor is chemically bonded/fixed is taken out from the solution followed by drying. The thiol group covers S-trityl-3-mercaptopropyloxy-β-cyanoethyl-N,N-diiso-propylaminophosphoramidide and the like and introduction of the thiol group into the end of the sensor may be carried out by a phosphoramidide method.

<Color Sensor and Apparatus for Inspection Using the Same>

The color sensor of the present invention is produced by aligning the capturing body onto a substrate material, in a film form.

The color sensor in the first aspect of the present invention is produced by aligning the capturing body 10 including the amphiphilic rod-shaped body 1 shown in FIG. 1 onto a substrate material, in a film form.

The color sensor in the second aspect of the present invention is produced by aligning the capturing body 10 including the amphiphilic rod-shaped body 1 shown in FIG. 2 and the capturing structure body 2 being bonded to the rod-shaped body 1 and specifically capturing a target substance onto a substrate material, in a film form.

The apparatus for inspection of the present invention includes the sensor and a color detecting unit detecting the change in the wavelength of the interference light or the change of the color tone with the color sensor due to the reflection of incident light as a colored interference light, when a target substance is attached or captured onto the color sensor.

Because the capturing body is amphiphilic, further, the capturing body is aligned vertically in the interface between the oil phase and the aqueous phase to be consequently in a film form, preferably, so that the change in wavelength of the interference light caused by a the light reflection of the incident light is readily detected.

The substrate material includes but is not limited to gold deposited substrate plate, silicone substrate plate and glass substrate plate.

Depending on the purpose, the method for aligning the capturing body comprising the color sensor onto a substrate plate in a film form can be selected appropriately, with no specific limitation. For example, the attachment and binding can be done by the Langmuir-Blodget's technique (LB technique) and chemical bindings such as covalent bonding.

The method for such covalent bonding is not specifically limited. For example, the same ones as in the aligning of the capturing body and the rod-shaped body can be appropriately selected and used.

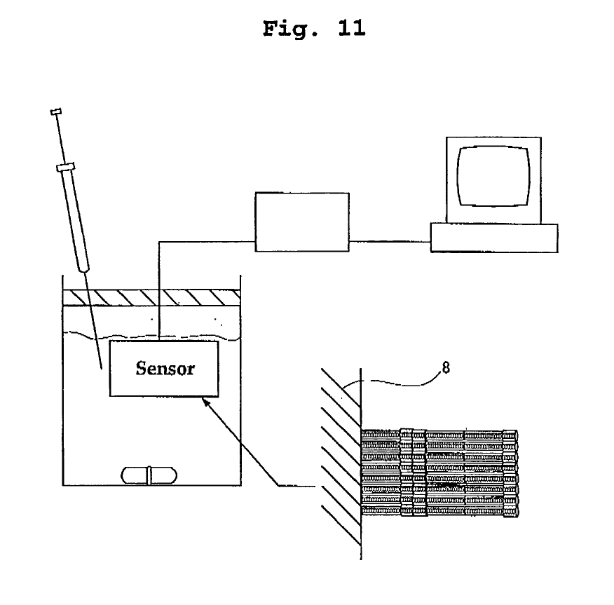

The apparatus for inspection using the color sensor of the present invention includes the color sensor and a color detecting unit which detects the change in the wavelength of the interference light or the change of the color tone with the color sensor due to the reflection of incident light as a colored interference light, when a target substance is attached or captured onto the color sensor. One example of such apparatus for inspection is shown in FIG. 11. Herein, the numeric FIG. ‘8’ in FIG. 11 expresses a substrate material, onto which the color sensor is to be bonded.

In this case, any color detecting unit capable of detecting the change in the wavelength of the interference light or the change of the color tone due to the reflection of incident light as a colored interference light can be used, with no specific limitation. For example, spectrophotometers and observation under naked eyes can be adopted as such color detecting unit.

When a target substance is attached onto the monolayer film of the color sensor or a laminate film thereof as prepared by laminating the monolayer film together or when a target substance is specifically captured or bonded onto the capturing structure body of the color sensor in the film form, the refractive index or length of the film is modified to cause the change in the wavelength or color tone due to the reflection of incident light as a colored interference light. Hence, the change in the wavelength or color tone is detected by a color detecting unit, for example spectrophotometer. Thus, the presence or absence of the target substance can be detected in a specific fashion.

By preliminarily preparing a standard curve using predetermined amounts of a target substance, the concentration of the target substance to be detected in a sample may be detected.

### EXAMPLES

The examples of the present invention are now described below. But the present invention is never limited to these examples.

### Example 1

A monolayer film of an α-helix polypeptide was formed on a silver electrode of a quartz oscillator (9 MHz, AT cut), to prepare the sensor of the present invention.

As the α-helix polypeptide, use was made of poly (n-hexyl L-glutamate (sometimes referred to as “PHeLG” hereinbelow)) with the monomer unit prepared by substituting the hydrogen atom in the carboxyl group of glutamic acid with n-hexyl group. The PHeLG was recovered by polymerization reaction of L-glutamate γ-methyl ester using benzylamine as a polymerization initiator. By ¹H-NMR, the polymerization degree was 114.

The method for binding the α-helix polypeptide onto the electrode of the quartz oscillator includes the steps of synthetically introducing thiol group in the end of the polypeptide, immersing the quartz oscillator in an aqueous solution of the resulting polypeptide for reaction, subsequently drawing out the resulting sensor from the aqueous solution and subsequently drying the sensor.

The resulting sensor was arranged as shown in FIG. 9. Then, an ethanol solution of β-ionone (odorous substance) as a target substance was added. The target substance was attached onto the sensor, to count the frequency due to the mass change.

### Example 2

An apparatus for inspection was fabricated in the same manner as in Example 1 except for the use of a surface acoustic wave (SAW) element with ST cut and an oscillation frequency of 10.3 MHz as shown in FIG. 10 instead of the quartz oscillator in Example 1.

Then, an ethanol solution of β-ionone (odorous substance) was added as a target substance. The target substance was attached onto the sensor, to count the frequency due to the mass change.

### Example 3

Using monoaminated β-cyclodextrin (β-CyD) as an initiator, polymerization of γ-methyl-L-glutamine-N-carboxylic anhydride was done to recover a polypeptide (PMG-CyD), in which β-CyD with the molecule recognition potency is arranged on the end of the molecular chain, as shown by the following formula.

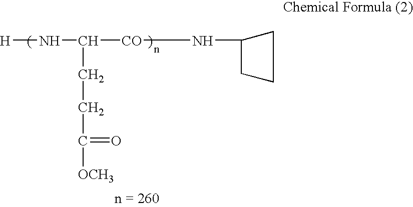

Using the polypeptide, a DMF solution of PMG-CyD was developed on the n-hexane/water interface formed on a Teflon® trough, to prepare a monolayer film.

The secondary structure of the primary chain of the resulting PMG-CyD molecule was assessed by circular dichroism (CD) spectrometry on the LB film laminated on a quartz plate. It was verified that in the monolayer film, the PMG-CyD molecule was in an α-helix structure.

The method for binding the α-helix polypeptide onto the electrode of the quartz oscillator includes the steps of introducing thiol group in the end of the polypeptide, immersing the quartz oscillator in an aqueous solution of the resulting polypeptide for reaction, subsequently drawing out the sensor from the aqueous solution and subsequently drying the sensor.

The resulting sensor was arranged as shown in FIG. 9. Then, an aqueous glucose solution was added as a target substance. The target substance was attached onto the sensor, to count the frequency due to the mass change.

### Example 4

An apparatus for inspection was fabricated in the same manner as in Example 1 except for the use of a surface acoustic wave (SAW) element with ST cut and an oscillation frequency of 10.3 MHz as shown in FIG. 10 instead of the quartz oscillator in Example 3.

Then, an aqueous glucose solution was added as a target substance. The target substance was attached onto the sensor, to count the frequency due to the mass change.

### Example 5

The color sensor of the present invention was prepared by forming the monolayer film of the α-helix polypeptide on a substrate plate and additionally laminating the same monolayer film on the resulting monolayer film, to prepare a laminate film.

The color sensor has a property to reflect incident light as a colored interference light, as described later. Further, the change of the color tone due to the capture of a target substance was verified.

As the α-helix polypeptide, use was made of poly (n-hexyl L-glutamate (sometimes referred to as “PHeLG” hereinbelow)) with the monomer unit prepared by substituting the hydrogen atom in the carboxyl group of glutamic acid with n-hexyl group. The PHeLG was recovered by polymerization reaction of L-glutamate γ-methyl ester using benzylamine as a polymerization initiator. By ¹H-NMR, the polymerization degree was 114. As the substrate plate, silicone substrate plate (manufactured by Shin-Etsu Chemical) surface-treated with octadecyl trimethoxysilane (manufactured by TOKYO KASEI KOGYO, CO., LTD.). The monolayer film was prepared, using an LB film preparation apparatus (NIPPON LASER & ELECTRONICS LAB.; NL-LB400NK-MWC). In the PHeLG, the helical pitch of the α-helix was 0.15 nm/one amino acid residue, while the diameter thereof was 1.5 nm.

The FT-IR spectrum of a laminate film made by laminating 120 layers of the monolayer film was measured. Four peaks were gained. One was a peak at 1738 cm⁻¹, based on the C═O group in the side chain. Additional one was a peak at 1656 cm⁻¹ at a high intensity, based on the amide group I in the α-helix structure. Another one was a small peak at 1626 cm⁻¹ at a low intensity, based on the amide group I in the β-structure. The final one was a peak at 1551 cm⁻¹, based on the amide group II in the α-helix structure. From the results of the measurement of the FT-IR spectrum, it was confirmed that the PHeLG molecule retained the α-helix structure in the monolayer film.

Because a laminate of 20 layers of the monolayer film of the PHeLG was 32-nm thick, the monolayer film of the PHeLG per one layer was calculated 1.6 nm-thick.

Then, the laminate film made by laminating 40 to 50 layers of the monolayer film exerted a light reflection of brown; the laminate film made by laminating 60 to 70 layers of the monolayer film exerted a light reflection of dark blue; the laminate film made by laminating 80 to 100 layers of the monolayer film exerted a light reflection of light blue; the laminate film made by laminating about 120 layers of the monolayer film exerted a light reflection of yellow; and the laminate film made by laminating up to 160 layers of the monolayer film exerted a light reflection of reddish purple.

An ethanol solution of β-ionone (odorous substance) was added as a target substance to a color sensor produced by laminating 60 to 70 layers of the monolayer film. The color tone was changed from dark blue or thick blue to light blue.

What is claimed is:

1. A sensor comprising:
a capturing body aligned in a form of film onto one of a quartz oscillator and a surface acoustic wave (SAW) element,
wherein the capturing body comprises an amphiphilic rod-shaped body.

2. A sensor according to claim 1, wherein the rod-shaped body is a helical organic molecule.

3. A sensor according to claim 2, wherein the helical organic molecule is any one of α-helix polypeptide, DNA and amylose.

4. A sensor according to claim 1, wherein the capturing structure body is bonded to one end of the rod-shaped body.

5. A sensor according to claim 1, wherein the capturing structure body is bonded to a circumferential side face of the rod-shaped body.

6. A sensor according to claim 1, wherein the form of film is in a monolayer form.

7. A sensor according to claim 1, wherein the form of film is in a multiple layer form.

8. A sensor comprising:
a capturing body aligned in a form of film onto one of a quartz oscillator and a surface acoustic wave (SAW) element,
wherein the capturing body comprises:
an amphiphilic rod-shaped body aligned in a form of film onto one of a quartz oscillator and a surface acoustic wave (SAW) element; and
a capturing structured body bonded to the amphiphilic rod-shaped body and which specifically captures a target substance.

9. A sensor according to claim 8, wherein the rod-shaped body is a helical organic molecule.

10. A sensor according to claim 9, wherein the helical organic molecule is any one of α-helix polypeptide, DNA and amylose.

11. A sensor according to claim 8, wherein the capturing structure body is bonded to one end of the rod-shaped body.

12. A sensor according to claim 8, wherein the capturing structure body is bonded to a circumferential side face of the rod-shaped body.

13. A sensor according to claim 8, wherein the form of film is in a monolayer form.

14. A sensor according to claim 8, wherein the form of film is in a multiple layer form.

15. A color sensor comprising a capturing body which comprises an amphiphilic rod-shaped body aligned in a form of film onto a substrate.

16. A color sensor according to claim 15, wherein the rod-shaped body is a helical organic molecule.

17. A color sensor according to claim 16, wherein the helical organic molecule is any one of α-helix polypeptide, DNA and amylose.

18. A color sensor according to claim 15, wherein the capturing structure body is bonded to one end of the rod-shaped body.

19. A color sensor according to claim 15, wherein the capturing structure body is bonded to a circumferential side face of the rod-shaped body.

20. A color sensor according to claim 15, wherein the form of film is in a monolayer form.

21. A color sensor according to claim 15, wherein the form of film is in a multiple layer form.

22. A color sensor according to claim 15, wherein the rod-shaped body has a length of 810 nm or less.

23. A color sensor according to claim 15, wherein a light interfered by the film is emphasized under the condition expressed by the equation (1) and enfeebled under the condition expressed by the equation (2):
$$\begin{matrix}λ = \frac{2 t1}{m} \sqrt{{n}^{2} - {sin}^{2} α} & ( 1 ) \\ λ = \frac{4 t1}{2 m - 1} \sqrt{{n}^{2} - {sin}^{2} α} & ( 2 )\end{matrix}$$
In the formulae (1) and (2), λ means wavelength (nm) of the interference light, α means angle of incidence (degree) of the light to the film, t means thickness (nm) of a single film, 1 means number of layers of the film, n means a refractive index of the film and m means an integer of 1 or more.

24. A color sensor comprising a capturing body aligned in a form of film onto a substrate, wherein the capturing body comprises:
an amphiphilic rod-shaped body aligned in a form of film onto one of a quartz oscillator and a surface acoustic wave (SAW) element; and
a capturing structured body bonded to the amphiphilic rod-shaped body and which specifically captures a target substance.

25. A color sensor according to claim 24, wherein the rod-shaped body is a helical organic molecule.

26. A color sensor according to claim 25, wherein the helical organic molecule is any one of α-helix polypeptide, DNA and amylose.

27. A color sensor according to claim 24, wherein the capturing structure body is bound to one end of the rod-shaped body.

28. A color sensor according to claim 24, wherein the capturing structure body is bound to a circumferential side face of the rod-shaped body.

29. A color sensor according to claim 24, wherein the form of film is in a monolayer form.

30. A color sensor according to claim 24, wherein the form of film is in a multiple layer form.

31. A color sensor according to claim 24, wherein the rod-shaped body has a length of 810 nm or less.

32. A color sensor according to claim 24, wherein a light interfered by the film is emphasized under the condition expressed by the equation (1) and enfeebled under the condition expressed by the equation (2):
$$\begin{matrix}λ = \frac{2 t1}{m} \sqrt{{n}^{2} - {sin}^{2} α} & ( 1 ) \\ λ = \frac{4 t1}{2 m - 1} \sqrt{{n}^{2} - {sin}^{2} α} & ( 2 )\end{matrix}$$
In the formulae (1) and (2), λ means wavelength (nm) of the interference light, α means angle of incidence (degree) of the light to the film, t means thickness (nm) of a single film, 1 means number of layers of the film, n means a refractive index of the film and m means an integer of 1 or more.

33. An apparatus for inspection comprising:
a sensor which comprises a capturing body aligned in a form of film onto one of a quartz oscillator and a surface acoustic wave (SAW) element, and the capturing body comprises an amphiphilic rod-shaped body;
an oscillation circuit which oscillates in a form of frequency a change in one of a mass and a visco-elasticity caused by one of an attachment and a capture of a target substance by the sensor; and
a frequency counter which counts the frequency generated from the oscillation circuit.

34. An apparatus for inspection according to claim 33, wherein the target substance is at least one type selected from protein, lipid, sugar, nucleic acid and a complex of them.

35. An apparatus for inspection according to claim 33, wherein the target substance is at least one type selected from fragrance, anesthetic drug, odorous substance, flavor, pharmaceutical drug, food ingredient, steroid hormone, dye and bitter substance.

36. An apparatus for inspection comprising:
a sensor which comprises a capturing body aligned in a form of film onto one of a quartz oscillator and a surface acoustic wave (SAW) element, in which the capturing body comprises: an amphiphilic rod-shaped body aligned in a form of film onto one of a quartz oscillator and a surface acoustic wave (SAW) element; and a capturing structured body bonded to the amphiphilic rod-shaped body and which specifically captures a target substance;
an oscillation circuit which oscillates in a form of frequency a change in one of a mass and a visco-elasticity caused by one of a n attachment and a capture of a target substance by the sensor; and
a frequency counter which counts the frequency generated from the oscillation circuit.

37. An apparatus for inspection according to claim 36, wherein the target substance is at least one type selected from protein, lipid, sugar, nucleic acid and a complex of them.

38. An apparatus for inspection according to claim 36, wherein the target substance is at least one type selected from fragrance, anesthetic drug, odorous substance, flavor, pharmaceutical drug, food ingredient, steroid hormone, dye and bitter substance.

39. An apparatus for inspection comprising:
a color sensor which comprises a capturing body comprising an amphiphilic rod-shaped body aligned in a form of film onto a substrate; and
means for detecting and measuring a color which measures a change in one of a wavelength of an interference light and a color tone caused by a light reflection as a colored interference light when a target substance is attached or captured onto the color sensor.

40. An apparatus for inspection according to claim 39, wherein the target substance is at least one type selected from protein, lipid, sugar, nucleic acid and a complex of them.

41. An apparatus for inspection according to claim 39, wherein the target substance is at least one type selected from fragrance, anesthetic drug, odorous substance, flavor, pharmaceutical drug, food ingredient, steroid hormone, dye and bitter substance.

42. An apparatus for inspection comprising:
a color sensor which comprises a capturing body aligned in a form of film onto a substrate, the capturing body comprises: an amphiphilic rod-shaped body aligned in a form of film onto one of a quartz oscillator and a surface acoustic wave (SAW) element; and a capturing structured body bonded to the amphiphilic rod-shaped body and which specifically captures a target substance; and
means for detecting and measuring a color which measures a change in one of a wavelength of an interference light and a color tone caused by a light reflection as a colored interference light when a target substance is attached or captured onto the color sensor.

43. An apparatus for inspection according to claim 42, wherein the target substance is at least one type selected from protein, lipid, sugar, nucleic acid and a complex of them.

44. An apparatus for inspection according to claim 42, wherein the target substance is at least one type selected from fragrance, anesthetic drug, odorous substance, flavor, pharmaceutical drug, food ingredient, steroid hormone, dye and bitter substance.
